(19) United States
(12) Patent Application Publication
(10) Pub. No.: US 2011/0058800 A1
(43) Pub. Date: Mar. 10, 2011

(54) HUMANOID ROBOT RECOGNIZING OBJECTS USING A CAMERA MODULE AND METHOD THEREOF

(75) Inventors: Kang Hee Lee, Seoul (KR); Woo Sup Han, Yongin-si (KR)

(73) Assignee: SAMSUNG ELECTRONICS CO., LTD., Suwon-si (KR)

(21) Appl. No.: 12/871,568

(22) Filed: Aug. 30, 2010

(30) Foreign Application Priority Data
Sep. 7, 2009 (KR) 10-2009-84011

(51) Int. Cl. G03B 17/00; G03B 11/00

(52) U.S. Cl. 396/73; 396/74; 396/544

(57) ABSTRACT

Disclosed herein is a humanoid robot and a method thereof, in which a best one of lenses or filters of a camera module is selectively substituted to improve object recognition performance. The humanoid robot includes a torso, a head connected to the torso, and a camera module installed on the head, and the camera module includes at least one of a lens member and a filter member, which selectively substitutes a part thereof according to a recognition state of an object.

### CROSS-REFERENCE TO RELATED APPLICATIONS

This application claims the benefit of Korean Patent Application No. 2009-84011, filed on Sep. 7, 2009 in the Korean Intellectual Property Office, the disclosure of which is incorporated herein by reference.

### BACKGROUND

1. Field

Example embodiments relate to a humanoid robot and method, in which a best one of lenses or filters of a camera module is selectively substituted to improve object recognition performance.

2. Description of the Related Art

In general, robots are machinery, which automatically conduct a work or operation, and are widely used as substitutes for humans or to assist humans in various fields.

Among these robots, industrial robots have the highest utilization. The industrial robots allow a production line to be automated and unmanned to improve productivity, and conduct dangerous operations on behalf of humans to protect humans from industrial disasters.

Recently, humanoid robots, which have an external appearance similar to humans and conduct motions similar to those of humans, have been developed. In the same manner as the industrial robots, these humanoid robots are supplied to various industrial spots and are used to conduct dangerous operations on behalf of humans. The most important advantage of the humanoid robots is to provide various services while living with humans in daily life rather than to substitute for humans.

Each of the humanoid robots includes a camera module mounted on its head, which serves as a visual sensor in order to recognize conditions around a position of an object (for example, a human face, an article, environment, etc). The camera module includes lenses, and image sensors to form images signal using light from the lenses.

The humanoid robot accurately recognizes a size of an object or a distance to an object through the camera module. However, the lenses of the camera module may not accurately recognize the object due to limitations of angles of view and focal lengths thereof.

### SUMMARY

Therefore, it is one aspect of the example embodiments to provide a humanoid robot, in which a best one of lenses or filters of a camera module are selectively substituted so as to improve object recognition performance.

Additional aspects will be set forth in part in the description which follows and, in part, will be obvious from the description, or may be learned by practice of the disclosure.

The foregoing and/or other aspects are achieved by providing a humanoid robot including a torso, a head connected to the torso, and a camera module installed on the head, wherein the camera module includes at least one of a lens member and a filter member, which selectively substitutes a part thereof according to a recognition state of an object.

The camera module may further include an image sensor member to capture images projected by the lens member, the lens member may include a lens holder rotated right and left around the image sensor member, and a plurality of lenses fixed to the lens holder and rotated in connection with rotation of the lens holder, and the lens holder may cause any one of the plurality of lenses to be selectively connected to the image sensor member.

The camera module may further include an image sensor member to capture images projected by the lens member, the lens member may include a lens holder fixed to the head, and lenses detachably connected to the lens holder, and the lens holder may include a lens connection groove, to which the lenses are selectively connected.

The camera module may further include an image sensor member to capture images projected by the lens member, the lens member may include a plurality of lens holders rotated upward and downward around the image sensor member, and a plurality of lenses respectively fixed to the plurality of lens holders and rotated in connection with rotation of the plurality of lens holders, and the plurality of lens holders may cause any one of the plurality of lenses to be selectively connected to the image sensor member.

The filter member may include a filter holder rotated right and left around the lens member, and a plurality of filters fixed to the filter holder and rotated in connection with rotation of the filter holder, and the filter holder may cause any one of the plurality of filters to be selectively connected to the lens member.

The filter member may include a filter holder fixed to the head, and filters detachably connected to the filter holder, and the filter holder may include a filter connection groove, to which the filters are selectively connected.

The filter member may include a plurality of filter holders rotated upward and downward around the lens member, and a plurality of filters respectively fixed to the plurality of filter holders and rotated in connection with rotation of the plurality of filter holders, and the plurality of filter holders may cause any one of the plurality of filters to be selectively connected to the lens member.

The lens holder may include a base part having a flat shape installed at the inside of the head, and support parts extended from the base part to support the plurality of lenses.

The humanoid robot may further include a driving device connected to the base part, and the base part may rotate the base part right and left according to images formed by the image sensor member such that the plurality of lenses is selectively substituted.

The humanoid robot may further include a lens storage unit provided within the torso.

The lens storage unit may be formed in a vacant space of one side of the torso.

Further, the lens storage unit may be formed in a bag on the rear surface of the torso.

The foregoing and/or other aspects are achieved by providing a humanoid robot including a torso, a head connected to the torso, and a camera module installed on the head, wherein the camera module includes an image sensor member to capture images, a lens member optically connected to the image sensor member to project images to the image sensor member, and a filter member installed in front of the lens member, and at least one of the lens member and the filter member, which selectively substitutes a part thereof according to a recognition state of an object.

Any one of the lens member and the filter member may be configured such that lenses or filters are connected to a lens holder or a filter holder rotated right and left to be selectively substituted.

Any one of the lens member and the filter member may be configured such that lenses or filters are detachably connected to the lens member or the filter member to be selectively substituted.

Any one of the lens member and the filter member may be configured such that lenses or filters are respectively connected to lens holders and filter holders rotated upward and downward to be selectively substituted.

The foregoing and/or other aspects are achieved by providing a method including capturing images using an image sensor member, a lens member optically connected to the image sensor member to project images to the image sensor member, and a filter member installed in front of the lens member; and selectively substituting at least one of the lens member and the filter member according to a recognition state of an object.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of the embodiments, taken in conjunction with the accompanying drawings of which:

FIG. 1 is a view illustrating an external appearance of a humanoid robot in accordance with example embodiments;

FIG. 2 is a view schematically illustrating a configuration of the humanoid robot of FIG. 1;

FIG. 3 is an enlarged top view of a head of the humanoid robot in accordance with example embodiments;

FIG. 4 is a longitudinal-sectional view taken along the line IV of FIG. 3;

FIG. 5 is a view illustrating a modification of the humanoid robot in accordance with example embodiments shown, for example, in FIG. 3;

FIG. 6 is a view illustrating a head of a humanoid robot in accordance with example embodiments;

FIG. 7 is an enlarged view of a lens member shown in FIG. 6;

FIG. 8 is a view illustrating a modification of the humanoid robot of FIG. 6;

FIG. 9 is a view illustrating a head of a humanoid robot in accordance with example embodiments; and

FIG. 10 is a view illustrating a modification of the humanoid robot of FIG. 9.

### DETAILED DESCRIPTION

Reference will now be made in detail to embodiments, examples of which are illustrated in the accompanying drawings, wherein like reference numerals refer to like elements throughout.

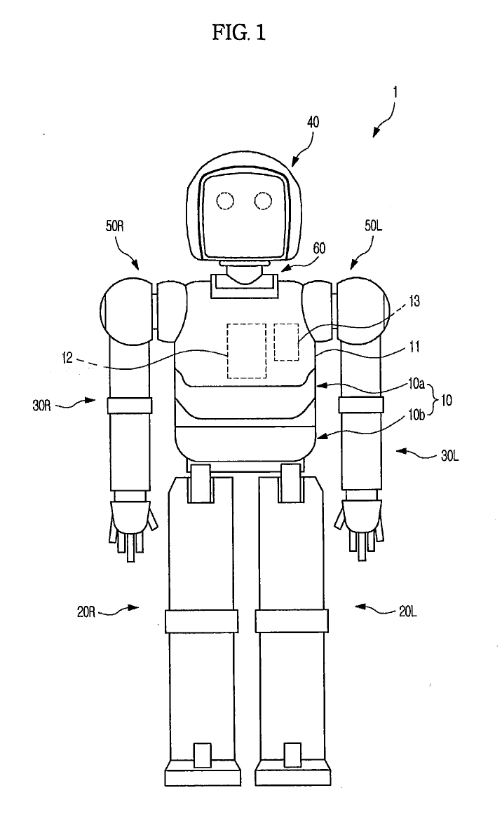

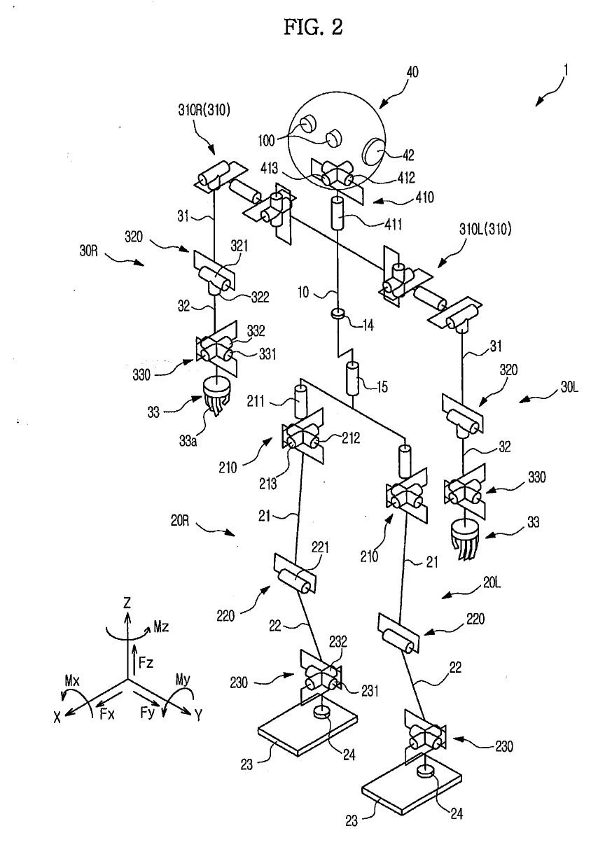

FIG. 1 is a view illustrating an external appearance of a humanoid robot in accordance with example embodiments, and FIG. 2 is a view schematically illustrating a configuration of the humanoid robot of FIG. 1.

As shown in FIGS. 1 and 2, a humanoid robot (hereinafter, simply referred to as a ‘robot’) 1 includes a torso 10, legs 20R and 20L connected to both sides of the lower portion of the torso 10, arms 30R and 30L connected to both sides of the upper portion of the torso 10, and a head 40 connected to the upper end of the torso 10. The arms 30R and 30L are respectively connected to the torso 10 through shoulders 50R and 50L, and the head 40 is connected to the torso 10 through a neck 60. Here, R and L respectively represent a right side and a left side.

The inside of the torso 10 is protected by a cover 11. A control unit 12, a battery 13, and an inclination sensor 14 (shown in FIG. 2) may be installed in the torso 10. The inclination sensor 14 detects an angle of inclination of the torso 10 relative to a vertical axis and its angular velocity.

The torso 10 is divided into a breast part 10a and a waist part 10b, and a joint 15 causing the breast part 10a to be relatively rotated against the waist part 10b is installed between the breast part 10a and the waist part 10b. FIG. 2 briefly illustrates the torso 10 as a torso link.

Both legs 20R and 20L respectively include thigh links 21, calf links 22, and feet 23 (shown in FIG. 2). The thigh links 21 are connected to the torso 10 through thigh joint units 210. The thigh links 21 and the calf links 22 are connected to each other by knee joint units 220, and the calf links 22 and the feet 23 are connected to each other by ankle joint units 230.

The thigh joints units 210 respectively have three degrees of freedom. In particular, the thigh joint units 210 respectively include rotary joints 211 rotated in a yaw direction (around the Z-axis), rotary joints 212 rotated in a pitch direction (around the Y-axis), and rotary joints 213 rotated in a roll direction (around the X-axis).

The knee joint units 220 respectively include rotary joints 221 rotated in the pitch direction, and thus have one degree of freedom. The ankle joint units 230 respectively include rotary joints 231 rotated in the pitch direction and rotary joints 232 rotated in the roll direction, and thus have two degrees of freedom.

Since the legs 20L and 20R respectively include six rotary joints for three joint units 210, 220, and 230, twelve rotary joints are provided for the two legs 20L and 20R. Although not shown in the drawings, motors to drive the rotary joints are respectively installed on the legs 20R and 20L. The control unit 12 properly controls the motors provided on the legs 20R and 20L, thereby achieving various motions of the legs 20R and 20L including walking of the robot 1.

Multi-axis force and torque (F/T) sensors 24 are respectively installed between the feet 23 and the ankle joint units 230 of the two legs 20L and 20R. The multi-axis F/T sensors 24 measure three directional components (Mx, My, Mz) of moment and three directional components (Fx, Fy, Fz) of force transmitted from the feet 23, and thus detect whether or not the feet 23 are on the ground or loads are applied to the feet 23.

A camera module 100 serving as the sense of sight of the robot 1 and microphones 42 serving as the sense of hearing of the robot 1 are installed at the head 40.

The head 40 is connected to the torso 10 through a neck joint unit 410. The neck joint unit 410 includes a rotary joint 411 rotated in the yaw direction, a rotary joint 412 rotated in the pitch direction, and a rotary joint 413 rotated in the roll direction, and thus has three degrees of freedom.

Head rotating motors (not shown) are respectively connected to the rotary joints 411, 412, and 413 of the neck joint unit 410. The control unit 12 controls the respective motors and thus drives the rotary joints 411, 412, and 413 at proper angles, thereby allowing the head 40 to move in a desired direction.

Both arms 30R and 30L respectively include upper arm links 31, lower arm links 32, and hands 33. The upper arm links 31 are connected to the torso 10 through shoulder joint assemblies 310. The upper arm links 31 and the lower arm links 32 are connected to each other through elbow joint units 320, and the lower arm links 32 and the hands 33 are connected to each other through wrist joint units 330.

The elbow joint units 320 respectively include rotary joints 321 rotated in the pitch direction and rotary joints 322 rotated in the yaw direction, and thus have two degrees of freedom. The wrist joint units 330 include rotary joints 331 rotated in the pitch direction and rotary joints 332 rotated in the roll direction, and thus have two degrees of freedom.

Five fingers 33a are installed at each of the hands 33. Each of the fingers 33a includes plural joints (not shown), respectively driven by motors. The fingers 33a perform various motions, such as gripping of an object and indicating of a special direction, in connection with the motion of the arms 30R and 30L.

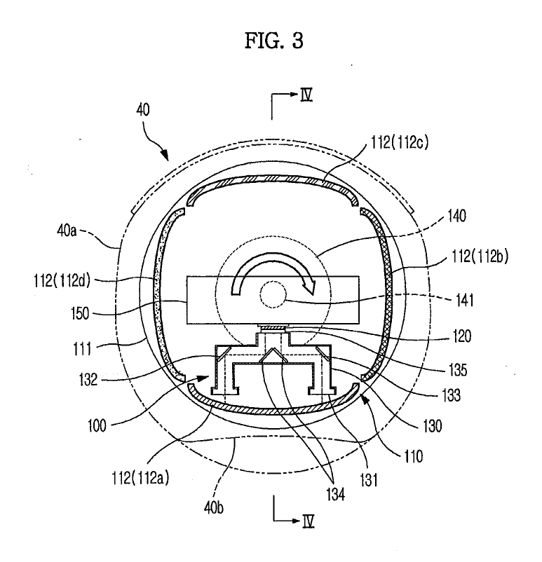

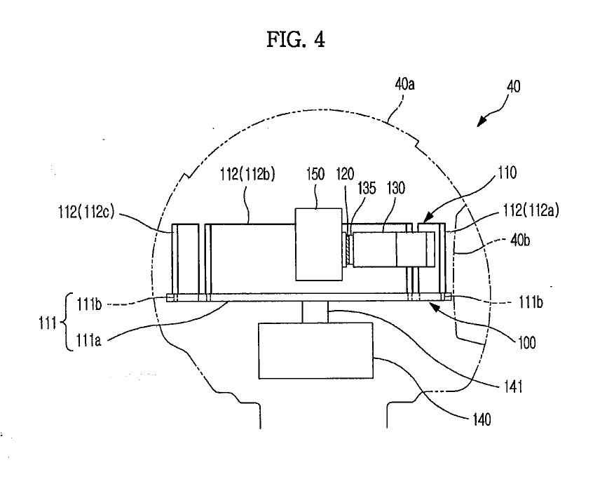

FIG. 3 is an enlarged top view of the head of the humanoid robot in accordance with the example embodiments, and FIG. 4 is a longitudinal-sectional view taken along the line IV—of FIG. 3.

As shown in FIGS. 3 and 4, the head 40 of the humanoid robot includes a helmet part 40a formed from the central portion thereof to a rear surface thereof, and a face part 40b formed at the front surface thereof. The helmet part 40a may be made of opaque plastic, and the face part 40b may be made of transparent plastic.

The camera module 100 used as a vision sensor of the humanoid robot is installed at the inside of the face part 40b. The camera module 100 includes a lens member 110, an image sensor member 120 to capture images projected by the lens member 110, and a connection member 130 to optically connect the lens member 110 and the image sensor member 120.

The image sensor member 120 is fixed to the inside of the face part 40b within the head 40, and images first formed by the image sensor member 120 are used as a signal to drive a driving device 140 such that the lens member 110 may be substituted.

The connection member 130 includes a lens connection part 131 facing the lens member 110, first and second reflection parts 132 and 133 installed in the lens connection part 131, central reflection parts 134 installed at a center between the first and second reflection parts 132 and 133, and a sensor connection member 135 facing the image sensor member 120 such that images reflected by the central reflection parts 134 are captured by the image sensor member 120.

Although the drawings illustrate that the connection member 130 includes the lens connection part 131, the first and second reflection parts 132 and 133, the central reflection parts 134, and the sensor connection member 135, since the connection member 130 serves only to optically connect the lens member 110 and the image sensor member 120, it would be appreciated by those skilled in the art that the lens member 110 and the image sensor member 120 may be optically connected using various methods.

The lens member 110 includes a lens holder 111 rotated right and left around the image sensor member 120 within the face part 40b, and a plurality of lenses 112 having different focal lengths, fixed to the lens holder 111, and rotated in connection with the rotation of the lens holder 111. Although the drawings illustrate that the lens member 110 is installed at the inside of the face part 40b, the lens member 110 may be installed at the outside of the face part 40b as well as at the inside of the face part 40b.

Among these lenses 112, a lens disposed at the front portion of the head 40 of the humanoid robot is referred to as a first lens 112a, a lens disposed at the left portion of the head 40 of the humanoid robot is referred to as a second lens 112b, a lens disposed at the rear portion of the head 40 of the humanoid robot is referred to as a third lens 112c, and a lens disposed at the right portion of the head 40 of the humanoid robot is referred to as a fourth lens 112d.

Although the drawings illustrate that four lenses 112 are connected to the lens holder 111, the number of the lenses 112 connected to the lens holder 111 is not limited to four.

The lens holder 111 is rotated such that any one of the first to fourth lenses 112a, 112b, 112c, and 112d is selectively connected to the image sensor member 120.

The lens holder 111 may be provided in a flat shape within the face part 40b. The first to fourth lenses 112a, 112b, 112c, and 112d are respectively fixed to the edge of the flat lens holder 111. The lens holder 111 is connected to the driving device 140, and the driving device 140 causes the lens holder 111 to be rotated along the inner circumference of the face part 40b.

The first to fourth lenses 112a, 112b, 112c, and 112d have different angles of view and different focal lengths, and are connected selectively to the connection member 130 and the image sensor member 120 according to the right and left rotation of the lens holder 111.

For example, in order to clearly recognize an object under a first recognition state, the humanoid robot may connect the first lens 112a to the connection member 130 and the image sensor member 120. Further, under a second recognition state, the humanoid robot may connect the second lens 112b to the connection member 130 and the image sensor member 120. In such a manner, the humanoid robot may selectively substitute a best one of the lenses 112 in order to clearly recognize an object according to various recognition states.

The lens holder 111 includes a base part 111a formed in a flat shape, and a plurality of support parts 111b extended from the base part 111a to support the plural lenses 112 such that the lenses 112 are respectively connected to the support parts 111b. The base part 111a of the lens holder 111 is connected to the driving device 140 at the central portion thereof. The driving device 140 includes a rotary shaft 141, which is the center of the right and left rotation of the lens holder 111.

Therefore, the lens holder 111 selects any one of the plural lenses 112 according to images formed on the image sensor member 120, thereby being capable of varying an angle of view and a focal distance of the camera module 100.

Accordingly, this selective substitution of the lenses 112 provides a zoom function and a wide function to the camera module 100, and thus reduces an unnecessary moving distance of the humanoid robot in order to clearly recognize an object.

Reference numeral 150 represents an image input board, by which an image signal from the camera module 100 is input and various forms of image processing are achieved.

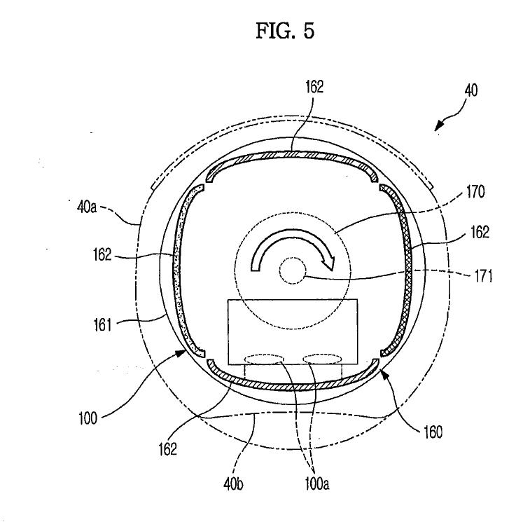

FIG. 5 is a view illustrating a modification of the humanoid robot in accordance with example embodiments shown, for example, in FIG. 3. As shown in FIG. 5, a camera module 100 in accordance with this modification includes a filter member 160 disposed such that the filter member 160 moves relative to a lens member 100a. The lens member 100a of the camera module 100 may include lenses of a well-known camera module.

The filter member 160 includes a filter holder 161 rotated right and left within the head 40, and a plurality of filters 162 connected to the filter holder 161.

The filters 162 of a small thickness are made of plastic having a property of absorbing rays of respective wavelengths. The filters 162 are provided in front of the lens member 100a, and serve to transform the color and shape of an object and to disperse light.

The filter holder 161 causes any one of the plural filters 162 to be selectively connected to the lens member 100a. The filter holder 161 is connected to a driving device 170, and the driving device 170 causes the filter holder 161 to be rotated right and left around the lens member 100a. Therefore, the humanoid robot may clearly recognize an object through the selective substitution of the filters 162.

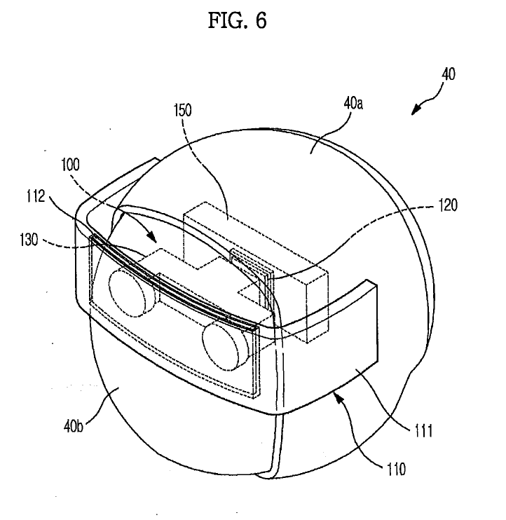

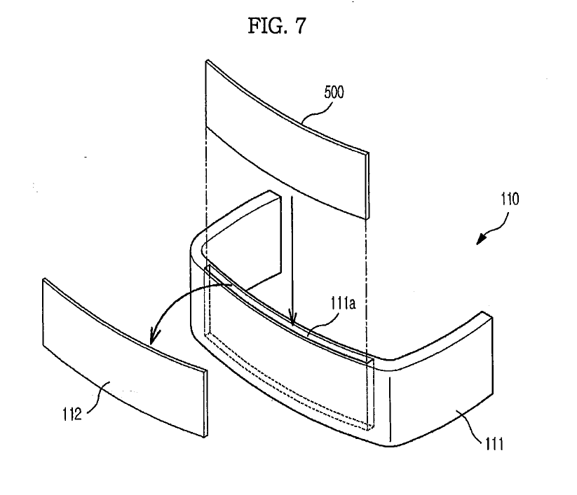

Further example embodiments will be described with reference to FIGS. 6 and 7. Some parts in FIGS. 6 and 7, which are substantially the same as those in the former embodiment of FIG. 3, are denoted by the same reference numerals even though they are depicted in different drawings, and a detailed description thereof will thus be omitted because it is considered to be unnecessary. FIG. 6 is a view illustrating a head of a humanoid robot in accordance with this embodiment, and FIG. 7 is an enlarged view of a lens member shown in FIG. 6.

As shown in FIGS. 6 and 7, a camera module 100 is installed at the inside and outside of a face part 40b of a head 40 of a humanoid robot in accordance with this embodiment.

The camera module 100 includes a lens member 110, an image sensor member 120 to capture images projected by the lens member 110, and a connection member 130 to optically connect the lens member 110 and the image sensor member 120.

The lens member 110 includes a lens holder 111 fixed to a helmet part 40a, and a lens 112 selectively inserted into the lens holder 111. The lens holder 111 includes a lens connection groove 111a, which causes the lens 112 to be selectively connected to the image sensor member 120.

The humanoid robot judges a recognition state of an object according to images formed on the image sensor member 120 under the condition that the lens 112 is inserted into the lens connection groove 111a, and then separates the lens 112 from the lens connection groove 111a and selects another lens 500, which is the best or most proper for the recognition state of the object, and inserts the lens 500 into the lens connection groove 111a. Therefore, the lens 500 may be selectively substituted.

If the lens holder 111 is not fixed to the helmet part 40a, an integral assembly of the lens holder 111 and the lens 112 may be selectively connected to the helmet part 40a of the head 40 according to the recognition state of an object.

The humanoid robot may be provided with a lens storage unit (not shown) storing a plurality of lenses 112 and 500 on the torso (not shown). The lenses 112 and 500 stored in the lens storage unit have different angles of view and different focal lengths, and the lens storage unit may be located at a position, which the arm (not shown) of the humanoid robot easily accesses.

For example, the lens storage unit may be located in a vacant space of one side of the torso of the humanoid robot, or may be located in a bag on the rear surface of the torso.

Therefore, the humanoid robot first judges a recognition state of an object, and selectively substitutes another lens 112 or 500 taken out of the side of the torso or the bag for the lens, which was already inserted into the lens connection groove 111a, thereby reducing an unnecessary moving distance in order to clearly recognize the object.

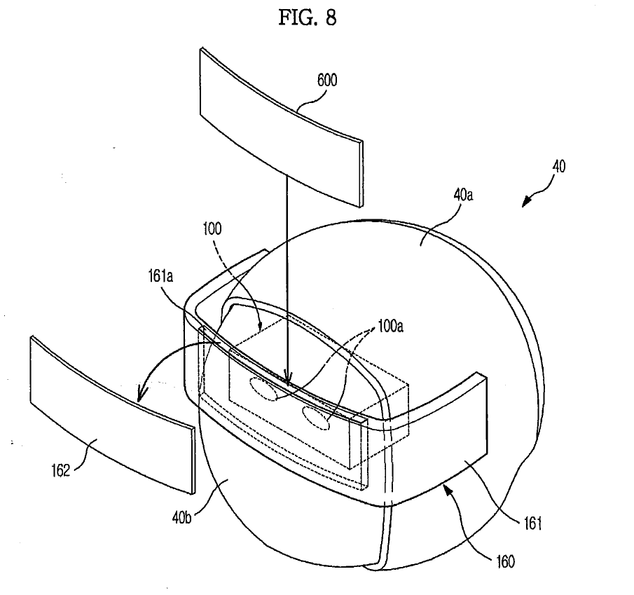

FIG. 8 is a view illustrating a modification of the humanoid robot of FIG. 6. As shown in FIG. 8, a camera module 100 in accordance with this modification includes a filter member 160 disposed such that the filter member 160 is detachably attached to a lens member 110a. The lens member 110a of the camera module 100 may include lenses of a well-known camera module.

The filter member 160 includes a filter holder 161 fixed to the helmet part 40a, and a filter 162 selectively inserted into the filter holder 161. The filter holder 161 includes a filter connection groove 161a, which causes the filter 162 to be selectively connected to the lens member 110a.

For example, the humanoid robot separates the filter 162 from the filter connection groove 161a using arms and hands thereof, and then selects another filter 600, which is the best or most proper for a recognition state of an object, from a filter storage unit (not shown) and inserts the filter 600 into the filter connection groove 161a. Therefore, the filter 600 may be selectively substituted. Therefore, the humanoid robot may clearly recognize an object through the selective substitution of the filter 600.

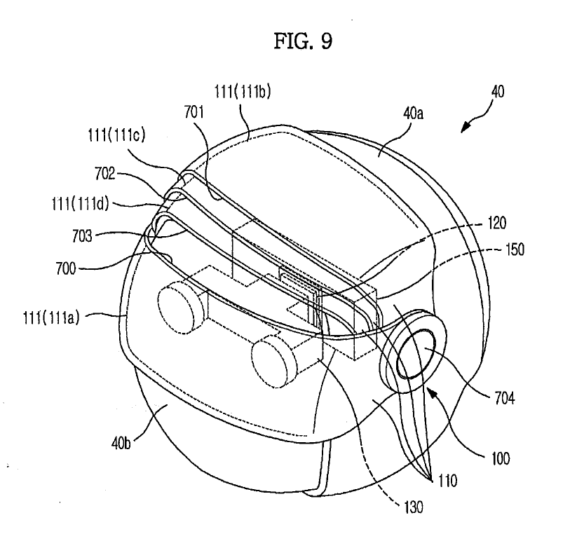

Example embodiments will be described with reference to FIG. 9. Some parts in FIG. 9, which are substantially the same as those in the former embodiment of FIG. 3, are denoted by the same reference numerals even though they are depicted in different drawings, and a detailed description thereof will thus be omitted because it is considered to be unnecessary. FIG. 9 is a view illustrating a head of a humanoid robot.

As shown in FIG. 9, a camera module 100 is installed at the inside and outside of a face part 40b of a head 40 of a humanoid robot in accordance with this embodiment. The camera module 100 includes a lens member 110, an image sensor member 120 to capture images projected by the lens member 110, and a connection member 130 to optically connect the lens member 110 and the image sensor member 120.

The lens member 110 includes a plurality of lens holders 111 connected to a helmet 40a such that the lens holders 111 are rotated upward and downward around the image sensor member 120, and lenses 700, 701, 702, and 703 respectively connected to the lens holders 111.

The plural lens holders 111 may include a first lens holder 111a, a second lens holder 111b, a third lens holder 111c, and a fourth lens holder 111d. A first lens 700 is connected to the first lens holder 111a. A second lens 701 having an angle of view and a focal length, differing from those of the first lens 700, is connected to the second lens holder 111b. A third lens 702 having an angle of view and a focal length, differing from those of the first lens 700 and the second lens 701, is connected to the third lens holder 111c. A fourth lens 703 having an angle of view and a focal length, differing from those of the first lens 700, the second lens 701, and the third lens 702, is connected to the fourth lens holder 111d.

Any one of the first to fourth lens holders 111 may be selectively connected to the image sensor member 120. For this reason, the first to fourth lens holders 111 are connected to a driving device (not shown).

Any one of the first to fourth lens holders 111 is rotated from the helmet part 40a to the face part 40b such that the corresponding one of the lenses 700, 701, 702, and 703 provided on the lens holders 111 is selectively connected to the connection member 130 and the image sensor member 120.

As shown in FIG. 9, in order to selectively connect the first lens 700 to the image sensor member 120, the first lens holder 111a is rotated downward and is located at the face part 40b. If it is judged that selective connection of any one of the second to fourth lenses 701, 702, and 703 to the image sensor member 120 allows clear recognition of an object, the first holder 111a is rotated upward, and then any one of the second to fourth lens holders 111 is rotated toward the face part 40b and is selectively connected to the image sensor member 120.

The first to fourth lens holders 111 are connected to a rotary shaft 704 at both sides of the helmet part 40a and the face part 40b. The first to fourth lens holders 111 are fixedly installed on the rotary shaft 704 and they are overlapped. Thus, the lenses 700, 701, 702, and 703 are selectively used based on judgment as to a recognition state of an object according to images formed on the image sensor member 120, thereby varying an angle of view and a focal length of the camera module 100. Therefore, the humanoid robot may clearly recognize an object through selective substitution of these lenses 700, 701, 702, and 703.

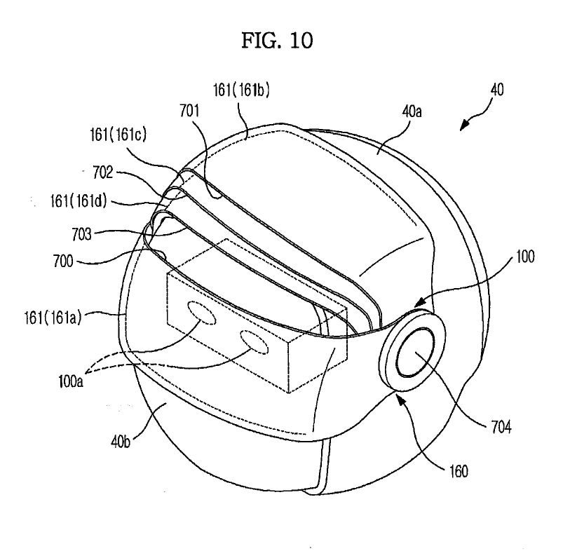

FIG. 10 is a view illustrating a modification of the humanoid robot of FIG. 9. As shown in FIG. 9, a camera module 100 in accordance with this modification includes a filter member 160 disposed such that the filter member 160 moves relative to a lens member 110a. The lens member 110a of the camera module 100 may include lenses of a well-known camera module.

The filter member 160 includes a plurality of filter holders 161 connected to a helmet 40a, and filters 700, 701, 702, and 703 respectively connected to the filter holders 161. Any one of the plural filter holders 161 is rotated upward and downward to face the lens member 110a such that the corresponding one of the filters 700, 701, 702, and 703 is selectively connected to the lens member 110a.

That is, as shown in FIG. 10, in order to selectively connect the first filter 700 to the lens member 110a, a first filter holder 161a is rotated downward. If it is judged that selective connection of any one of the second to fourth filters 701, 702, and 703 to the lens member 110a allows clear recognition of an object, the first filter 111a is rotated upward, and then any one of second to fourth filter holders 161b, 161c, and 161d, is rotated downward and is selectively connected to the lens member 110a.

The filter holders 161 are connected to a driving device (not shown), and the driving device selectively rotates the filter holders 161 upward and downward around the lens member 110a and thus allows one of the filters 700, 701, 702, and 703, which is the best or most proper for the recognition state of an object, to be connected to the lens member 110a. Therefore, the humanoid robot may clearly recognize an object through selective substitution of these filters 700, 701, 702, and 703.

As is apparent from the above description, in a humanoid robot in accordance with one embodiment, a best or proper one of lenses or filters of a camera module is selectively substituted, thereby improving object recognition performance.

Although embodiments have been shown and described, it should be appreciated by those skilled in the art that changes may be made in these embodiments without departing from the principles and spirit of the disclosure, the scope of which is defined in the claims and their equivalents.

What is claimed is:

1. A humanoid robot comprising a torso, a head connected to the torso, and a camera module installed on the head,
wherein the camera module includes at least one of a lens member and a filter member, which selectively substitutes a part thereof according to a recognition state of an object.

2. The humanoid robot according to claim 1, wherein:
the camera module further includes an image sensor member to capture images projected by the lens member;
the lens member includes a lens holder rotated right and left around the image sensor member, and a plurality of lenses fixed to the lens holder and rotated in connection with rotation of the lens holder; and
the lens holder causes any one of the plurality of lenses to be selectively connected to the image sensor member.

3. The humanoid robot according to claim 1, wherein:
the camera module further includes an image sensor member to capture images projected by the lens member;
the lens member includes a lens holder fixed to the head, and lenses detachably connected to the lens holder; and
the lens holder includes a lens connection groove, to which the lenses are selectively connected.

4. The humanoid robot according to claim 1, wherein:
the camera module further includes an image sensor member to capture images projected by the lens member;
the lens member includes a plurality of lens holders rotated upward and downward around the image sensor member, and a plurality of lenses respectively fixed to the plurality of lens holders and rotated in connection with rotation of the plurality of lens holders; and
the plurality of lens holders causes any one of the plurality of lenses to be selectively connected to the image sensor member.

5. The humanoid robot according to claim 1, wherein:
the filter member includes a filter holder rotated right and left around the lens member, and a plurality of filters fixed to the filter holder and rotated in connection with rotation of the filter holder; and
the filter holder causes any one of the plurality of filters to be selectively connected to the lens member.

6. The humanoid robot according to claim 1, wherein:
the filter member includes a filter holder fixed to the head, and filters detachably connected to the filter holder; and
the filter holder includes a filter connection groove, to which the filters are selectively connected.

7. The humanoid robot according to claim 1, wherein:
the filter member includes a plurality of filter holders rotated upward and downward around the lens member, and a plurality of filters respectively fixed to the plurality of filter holders and rotated in connection with rotation of the plurality of filter holders; and
the plurality of filter holders causes any one of the plurality of filters to be selectively connected to the lens member.

8. The humanoid robot according to claim 2, wherein the lens holder includes a base part having a flat shape installed at the inside of the head, and support parts extended from the base part to support the plurality of lenses.

9. The humanoid robot according to claim 8, further comprising a driving device connected to the base part,
wherein the base part rotates the base part right and left according to images formed by the image sensor member such that the plurality of lenses is selectively substituted.

10. The humanoid robot according to claim 1, further comprising a lens storage unit provided within the torso.

11. The humanoid robot according to claim 10, wherein the lens storage unit is formed in a vacant space of one side of the torso.

12. The humanoid robot according to claim 10, wherein the lens storage unit is formed in a bag on the rear surface of the torso.

13. A humanoid robot comprising a torso, a head connected to the torso, and a camera module installed on the head, wherein:
the camera module includes an image sensor member to capture images, a lens member optically connected to the image sensor member to project images to the image sensor member, and a filter member installed in front of the lens member; and
at least one of the lens member and the filter member, which selectively substitutes a part thereof according to a recognition state of an object.

14. The humanoid robot according to claim 13, wherein any one of the lens member and the filter member may be configured such that lenses or filters are connected to a lens holder or a filter holder rotated right and left to be selectively substituted.

15. The humanoid robot according to claim 13, wherein any one of the lens member and the filter member may be configured such that lenses or filters are detachably connected to the lens member or the filter member to be selectively substituted.

16. The humanoid robot according to claim 13, wherein any one of the lens member and the filter member may be configured such that lenses or filters are respectively connected to lens holders and filter holders rotated upward and downward to be selectively substituted.

17. A method, comprising:
capturing images using an image sensor member, a lens member optically connected to the image sensor member to project images to the image sensor member, and a filter member installed in front of the lens member; and
selectively substituting at least one of the lens member and the filter member according to a recognition state of an object.

18. The method according to claim 17, wherein any one of the lens member and the filter member may be configured such that lenses or filters are connected to a lens holder or a filter holder rotated right and left to be selectively substituted

19. The method according to claim 17, wherein any one of the lens member and the filter member may be configured such that lenses or filters are detachably connected to the lens member or the filter member to be selectively substituted.

20. The method according to claim 17, wherein any one of the lens member and the filter member may be configured such that lenses or filters are respectively connected to lens holders and filter holders rotated upward and downward to be selectively substituted.
